(19) United States
(12) Patent Application Publication
(10) Pub. No.: US 2011/0157076 A1
(43) Pub. Date: Jun. 30, 2011

(54) Method and Apparatus for Adjusting Touch Control Parameter

(76) Inventors: Hui-Hung Chang, Keelung City (TW); Meng-Hsiu Wu, Hsinchu City (TW); Chun-Hung Chen, Taipei City (TW)

(21) Appl. No.: 12/885,583

(22) Filed: Sep. 20, 2010

(30) Foreign Application Priority Data
Dec. 30, 2009 (TW) 098145968

(51) Int. Cl. G06F 3/045; G06F 3/044

(52) U.S. Cl. 345/174; 178/18.06

(57) ABSTRACT

A method utilized for adjusting touch control parameters, for deciding time for updating a touch control parameter of a touch control device, is disclosed. The touch control parameter includes an equivalent value of base capacitance corresponding to an environmental capacitance and a threshold value corresponding to a touch event. The method includes determining an amount of a touch sensing signal being located in an invalid range when the touch sensing signal is located in the invalid range, and starting to update the equivalent value of base capacitance when the amount of the touch sensing signal being located in the invalid range is greater than a first default value.

### BACKGROUND OF THE INVENTION

1. Field of the Invention

The present invention relates to a method and device for adjusting touch control parameters, and more particularly, to a method and device capable of compensating abnormal or rapid change of an environmental capacitance in order to accurately determine a variation of human body capacitance.

2. Description of the Prior Art

A touch panel has merits of convenient operation, rapid response, and saving space, such that the touch panel has been widely used in various consumer electronic products, such as personal digital assistant (PDA), personal computer, smart mobile phone, notebook, and point of sale system (POS). A capacitive touch technique, one of the most popular touch techniques, further includes merits of stable performance, excellent sensitivity and durability, and utilizes capacitive variations of static electricity generated by proximity or contact between a human body and a touch panel, to achieve a touch function.

Please refer to FIG. 1. FIG. 1 is a schematic of a capacitive touch system 10 in the prior art. The capacitive touch system 10 includes a touch panel 102, a sense unit 104, and a determination unit 106. The touch panel 102 includes a plurality of wires (e.g. ITO) arranged as a matrix. The sense unit 104 senses capacitances of the wires, transforms the sensed capacitances into digital signals, and output the digital signals to the determination unit 106. When a human body (e.g. a finger) touches the touch panel 102, capacitances of some wires vary, such that the determination unit 106 determines a touch event according to the signals outputted from the sense unit 104, and informs backend application units or controllers to output corresponding effects.

In detail, please refer to FIG. 2. FIG. 2 is a schematic diagram of a signal ctr_raw sensed by the sense unit 104 when a touch event occurs. In order to sense a capacitance variation caused by a human body, touch control parameters are predefined in the sense unit 104 as reference for sensing touch events. As shown in FIG. 2, the touch parameters include an equivalent value of base capacitance ctr_bsc, a touch threshold th_on, a high noise threshold th_ns_high, and a low noise threshold th_ns_low. The value ctr_bsc is corresponding to an environmental capacitance, while the touch threshold th_on is utilized for determining whether a touch event occurs. The high noise threshold th_ns_high and the low noise threshold th_ns_low are respectively a sum and a difference between the value ctr_bsc and a noise margin mrg_ns, for avoiding erroneous decisions. When no finger touches the touch panel 102, the signal ctr_raw sensed by the sense unit 104 is located between the high noise threshold th_ns_high and the low noise threshold th_ns_low. When a finger touches the touch panel 102, the signal ctr_raw first exceeds the high noise threshold th_ns_high, and then exceeds the touch threshold th_on, meaning a valid touch event rather than noise interference. Therefore, to accurately determine the touch event, the value ctr_bsc is required to be accurate.

In the prior art, for obtaining the value ctr_bsc of accuracy, as illustrated in FIG. 3, after starting or restarting, the capacitive touch system 10 continuously monitors an environmental capacitance conversion value cap_ev of the touch panel 102 for a while, averages reasonable environmental capacitance conversion values cap_ev within the monitoring duration to a stable value ctr_bsc, and stores the value ctr_bsc in the capacitive touch system 10. Meanwhile, the capacitive touch system 10 automatically updates the value ctr_bsc to compensate parameter shifts caused by variations of temperature or humidity under normal operations. However, even so, the value ctr_bsc may still be wrongly determined or unable to be updated.

For example, if an abnormal capacitance medium touches the touch panel 102 in the boot process of the capacitive touch system 10, e.g. a finger or a touch pen continuously touches the touch panel 102 or oil or water adheres thereupon, the value ctr_bsc obtained in a startup process of the capacitive touch system 10 would be higher than a real conversion value of the environment. Under such circumstances, after the capacitive touch system 10 finishes the boot process, if the abnormal capacitance medium moves off the touch panel 102 (the finger moves off the touch panel 102, or the user wipes the residual oil or water off), the capacitive touch system 10 cannot accurately compare the variation of capacitance caused by the human body.

In addition, although the capacitive touch system 10 automatically updates the value ctr_bsc under normal operations, such an updating mechanism can only deal with a smooth variation of environmental capacitance. When the temperature or the humidity changes rapidly, e.g. the user moves from a snowing outdoors into a heated room, the environmental capacitance can change rapidly, which may exceeds a reaction range of the updating mechanism of the capacitive touch system 10. Under such circumstances, the capacitive touch system 10 cannot accurately compare the variation of capacitance caused by the human body, and an operation failure occurs as well.

### SUMMARY OF THE INVENTION

It is therefore a primary objective of the claimed invention to provide a method and device for adjusting touch control parameters.

The present invention discloses a method for adjusting touch control parameters, for deciding time for updating a touch control parameter of a touch control device. The touch control parameter includes an equivalent value of base capacitance corresponding to an environmental capacitance and a threshold value corresponding to a touch event. The method includes determining an amount of a touch sensing signal being located in an invalid range when the touch sensing signal is located in the invalid range, and starting to update the equivalent value of base capacitance when the amount of the touch sensing signal being located in the invalid range is greater than a first default value.

The present invention further discloses a device for adjusting touch control parameters, for deciding time for updating a touch control parameter of a touch control device. The touch control parameter includes an equivalent value of base capacitance corresponding to an environmental capacitance and a threshold value corresponding to a touch event. The device includes a numeric determination unit, for determining an amount of a touch sensing signal being located in an invalid range when the touch sensing signal is located in the invalid range, and an update trigger unit, for starting to update the equivalent value of base capacitance when the amount of the touch sensing signal being located in the invalid range is greater than a first default value.

The present invention further discloses a method for adjusting touch control parameters, for deciding time for updating a touch control parameter of a touch control device. The touch control parameter includes an equivalent value of base capacitance corresponding to an environmental capacitance and a threshold value corresponding to a touch event. The method includes determining an amount of a plurality of touch sensing signals being located in an invalid range when the plurality of touch sensing signals are simultaneously located in the invalid range, and starting to update the equivalent value of base capacitance when the amount of the plurality of touch sensing signals is greater than a first default value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic of a capacitive touch system according to the prior art.

FIG. 2 is a schematic diagram of a signal sensed by a sense unit in the capacitive touch system in FIG. 1 when a touch event occurs.

FIG. 3 is a schematic diagram of the boot process of the capacitive touch system in FIG. 1.

FIG. 4 is a schematic diagram of a touch control parameter adjusting process according to an embodiment of the present invention.

FIG. 5 is a schematic diagram of a touch control parameter adjusting process according to an embodiment of the present invention.

FIG. 6, FIG. 7, FIG. 8A, FIG. 8B, and FIG. 9 are schematic diagrams of operations of the touch control parameter adjusting device in FIG. 4.

### DETAILED DESCRIPTION

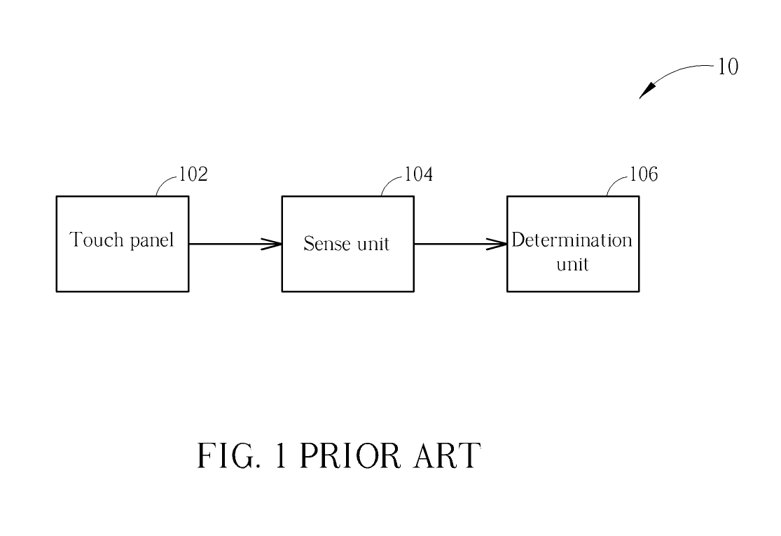

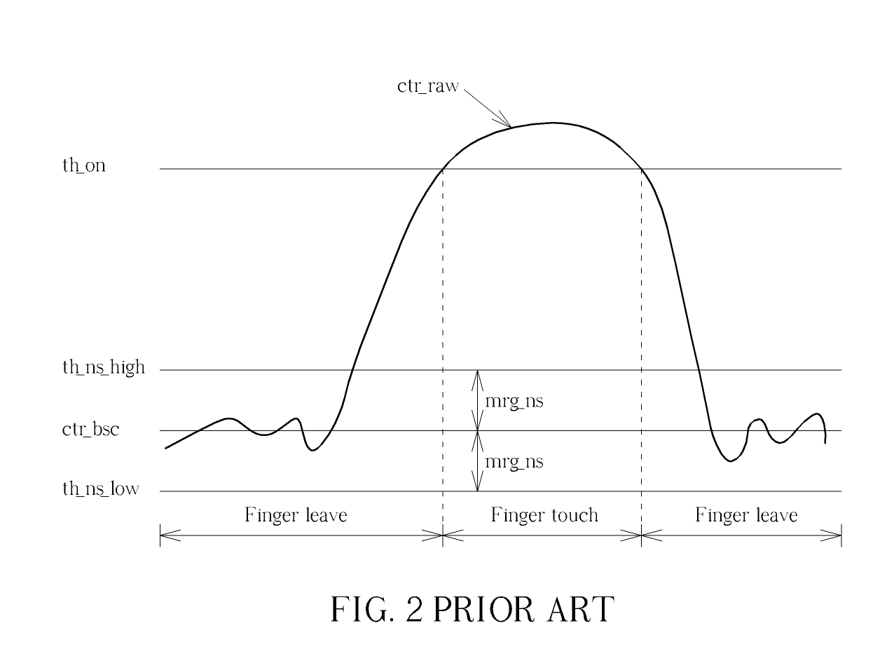

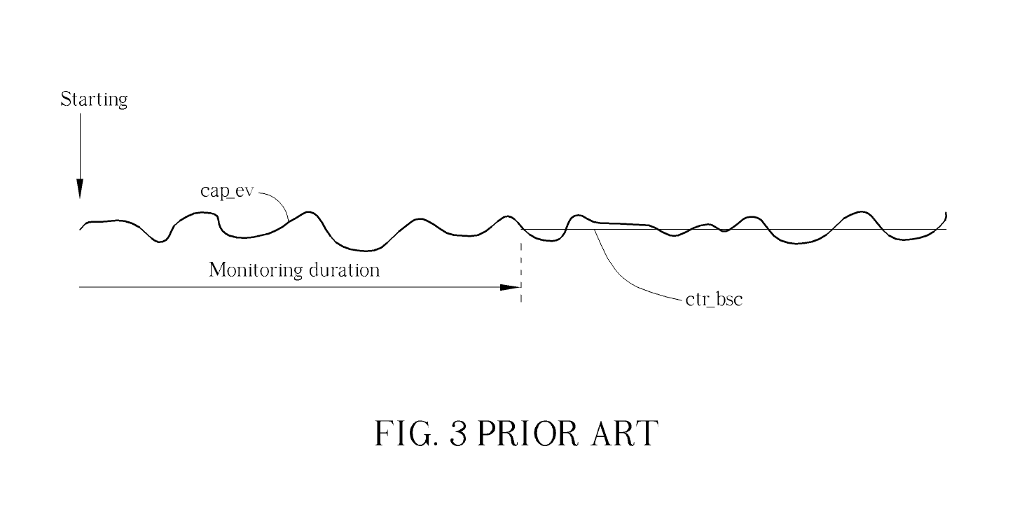

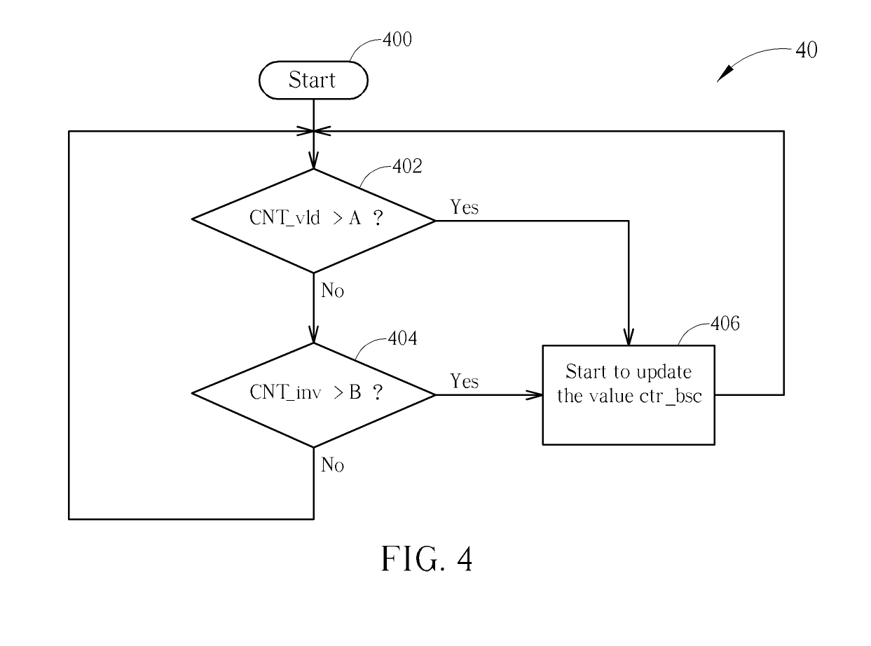

Please refer to FIG. 4. FIG. 4 is a schematic diagram of a touch control parameter adjusting process 40 according to an embodiment of the present invention. The touch control parameter adjusting process 40 is utilized in the capacitive touch system 10 as shown in FIG. 1 to decide the time for updating touch control parameters of the sense unit 104, and includes the following steps:

Step 400: Start.

Step 402: Determine whether a value CNT_vld, referring to the amount of touch sensing signals simultaneously located in a valid range, is greater than a default value A. If true, perform step 406; else, perform step 404.

Step 404: Determine whether a value CNT_inv, referring to the times of a touch sensing signal located in an invalid range, is greater than a default value B. If true, perform step 406; else, go back to step 402.

Step 406: Start to update the value ctr_bsc.

The touch control parameter adjusting process 40 determines whether to start to update the value ctr_bsc according to the value CNT_vld, i.e. the amount of touch sensing signals simultaneously located in the valid range, and the value CNT_inv, i.e. the accumulated number of times the touch sensing signal is located in the invalid range. The “valid range” specified herein is a range of sense capacitance conversion values capable of being determined as touch events, e.g. a range greater than the touch threshold th_on as shown in FIG. 2. The “invalid range” specified herein is a range of sense capacitance conversion values that cannot be used for determining whether a touch event occurs, e.g. a range between the touch threshold th_on and the high noise threshold th_ns_high, or a range smaller than the low noise threshold th_ns_low, as shown in FIG. 2. Note that, definitions of the valid range and the invalid range are related to system requirements, and are not limited to the above.

Therefore, when the sensing result of the sense unit 104 indicates that an amount of touch events simultaneously occurring on the touch panel 102 is greater than ‘A’ (such as 2), or accumulated times of a touch sensing signal that cannot used for determining whether a touch event occurs is greater than ‘B’, the touch control parameter adjusting process 40 starts to update the value ctr_bsc.

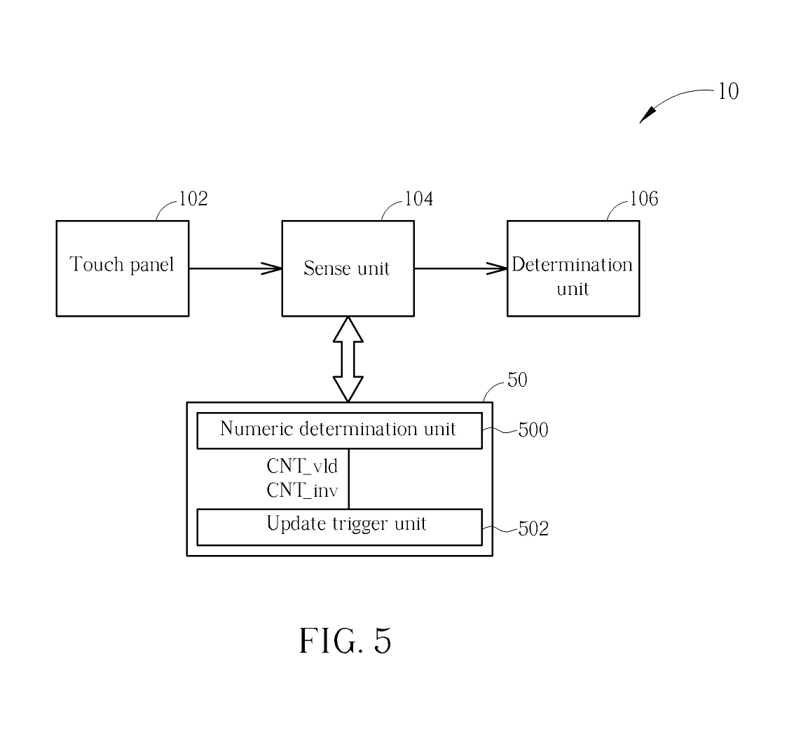

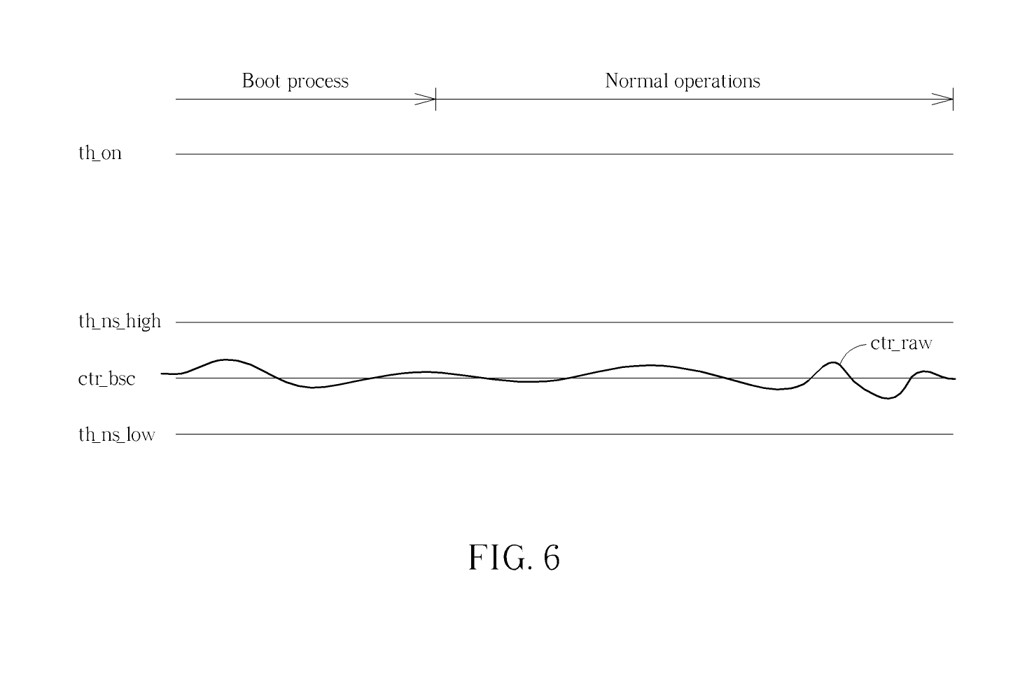

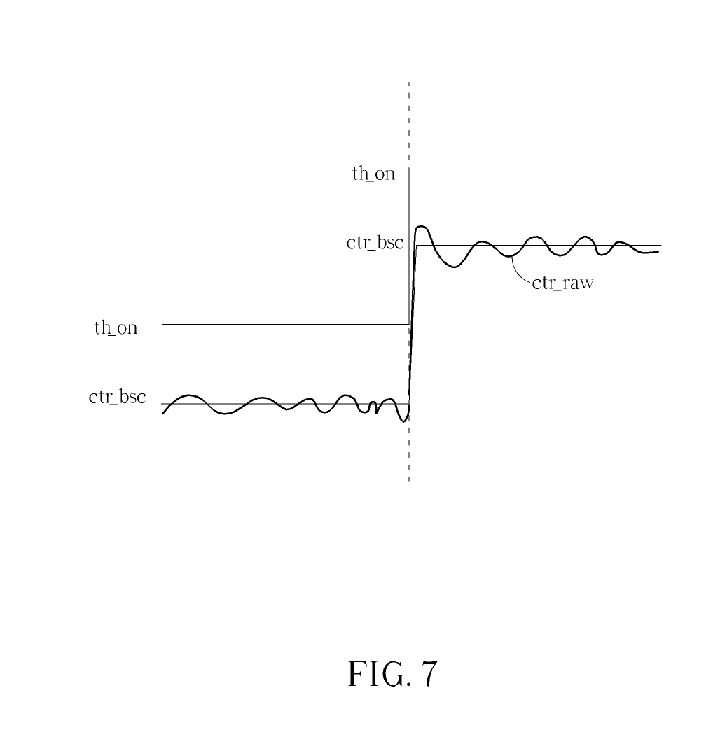

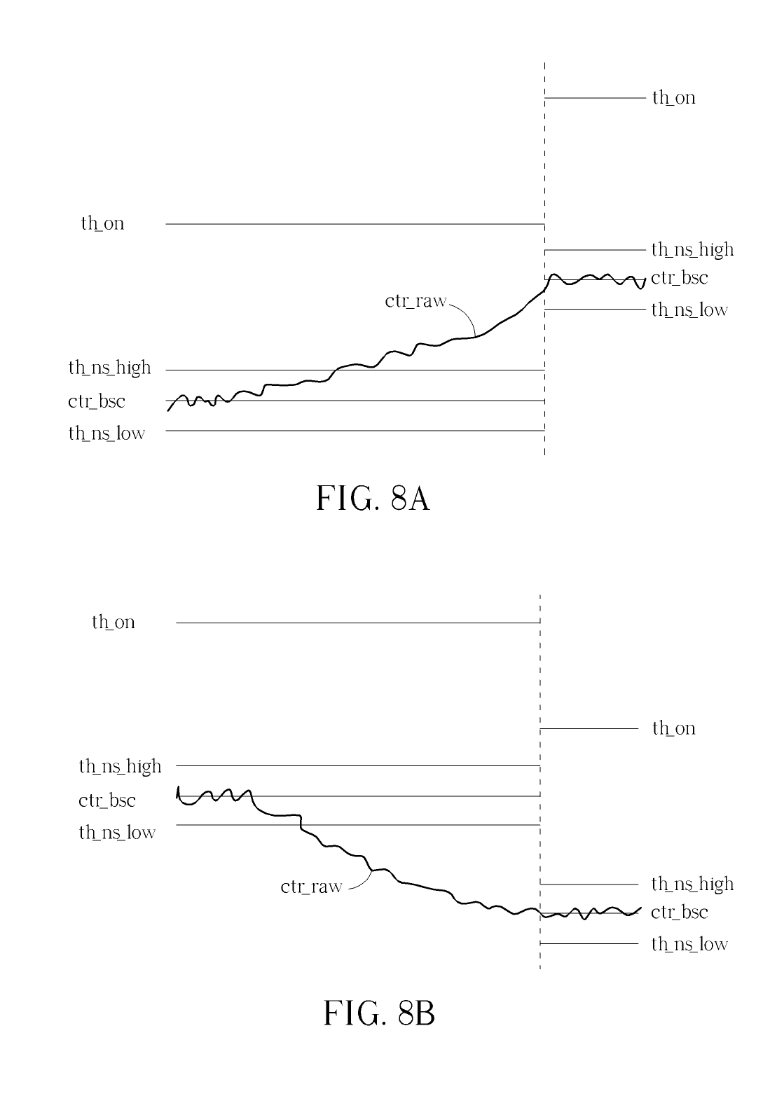

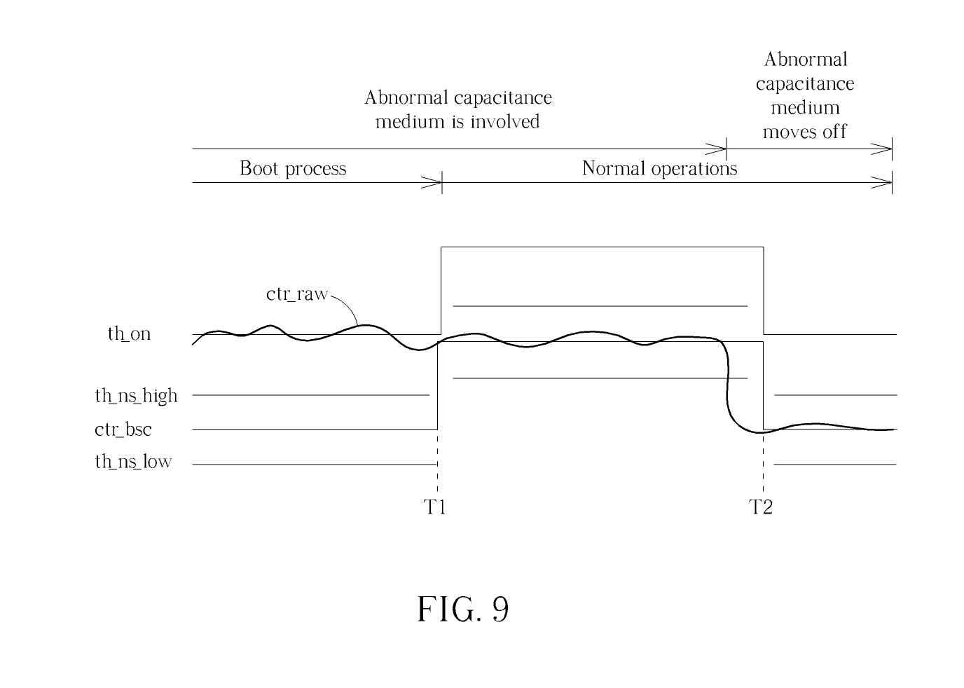

Implementation of the touch control parameter adjusting process 40 is not limited to software or hardware, and the related functional blocks can be added to the capacitive touch system 10 in FIG. 1 via software update, or adding or modifying hardware circuits, as illustrated in FIG. 5. In FIG. 5, an added touch control parameter adjusting device 50 is used for implementing the touch control parameter adjusting process 40, to timely start to update the touch control parameters of the sense unit 104. The touch control parameter adjusting device 50 includes a numeric determination unit 500 and an update trigger unit 502. The numeric determination unit 500 is utilized for determining the value CNT_vld and the value CNT_inv, while the update trigger unit 502 determines whether to update the value ctr_bsc according to a determination result of the numeric determination unit 500. When the value CNT_vld is greater than the default value A or the value CNT_inv is greater than the default value B, the update trigger unit 502 starts to update the value ctr_bsc. Hence, operations of the touch control parameter adjusting device 50 can be categorized into four situations as follows and illustrated in FIG. 6, FIG. 7, FIG. 8A, FIG. 8B, and FIG. 9.

First, suppose the temperature and the humidity conform to predetermined operation conditions, and the numeric determination unit 500 determines that the value CNT_vld is greater than the default value A and the value CNT_inv is greater than the default value B. That is, the environmental capacitance conversion value (i.e. the signal ctr_raw) determined by the sense unit 104 approximately equals the value ctr_bsc but does not exceed the range between the high noise threshold th_ns_high and the low noise threshold th_ns_low. The touch control parameter adjusting device 50 does not start to update the value ctr_bsc, as illustrated in FIG. 6.

Second, under normal operations, if the numeric determination unit 500 determines that the value CNT_vld is greater than the default value A, i.e. the amount of touch events detected simultaneously is greater than the default value A, the touch control parameter adjusting device 50 starts to update the value ctr_bsc, as illustrated in FIG. 7.

Third, under normal operations, the numeric determination unit 500 determines that the value CNT_inv is greater than the default value B. That is, as shown in FIG. 8A, among the environmental capacitance conversion values (i.e. the signal ctr_raw) determined by the sense unit 104, the amount of capacitance conversion values between the touch threshold th_on and the high noise threshold th_ns_high is greater than the default value B, or, as shown in FIG. 8B, the amount of capacitance conversion values under the low noise threshold th_ns_low is greater than the default value B. Then, the update trigger unit 502 starts to update the value ctr_bsc.

Fourth, if an abnormal capacitance medium is involved in the boot process, as shown in FIG. 9, the numeric determination unit 500 first starts to update the value ctr_bsc at timing T1 to compensate influence caused by the abnormal capacitance medium, and after the abnormal capacitance medium moves off, the numeric determination unit 500 updates the value ctr_bsc again at timing T2.

The above four situations are used to specify the concept of the present invention. Note that, the default values A and B should be set according to system requirements. Take FIG. 9 as an example, to enhance system reaction time, i.e. advancing the timing T2, the default value B should be set smaller; on the contrary, to enhance system stability, the default value B should be set greater.

In the prior art, if the abnormal capacitance medium affects the determination of the environmental capacitance in the boot process of the capacitive touch system, and the abnormal capacitance medium moves off after the boot process, the capacitive touch system cannot accurately compare the variation of capacitance caused by the human body. In addition, a rapid change of the environmental capacitance caused by rapid changes of the temperature or the humidity may also exceed the reaction range of the updating mechanism in the prior art capacitive touch system. In comparison, the present invention determines whether to start to update the value ctr_bsc according to the amount of touch sensing signals simultaneously located in the valid range and the times of the touch sensing signal located in the invalid range. Hence, regardless of the influence caused by the abnormal capacitance medium and the rapid change of the environmental capacitance, the present invention is capable of tracking the variation of the value ctr_bsc, so as to accurately determine the variation of capacitance caused by the human body.

To sum up, the present invention can compensate the influence of the abnormal capacitance medium or the rapid change of the environmental capacitance, to effectively track the variation of base capacitance, so as to accurately determine the variation of capacitance caused by the human body.

Those skilled in the art will readily observe that numerous modifications and alterations of the device and method may be made while retaining the teachings of the invention.

What is claimed is:

1. A method for adjusting touch control parameters, for deciding time for updating a touch control parameter of a touch control device, the touch control parameter comprising an equivalent value of base capacitance corresponding to an environmental capacitance and a touch threshold corresponding to a touch event, the method comprising:
determining an amount of a touch sensing signal being located in an invalid range when the touch sensing signal is located in the invalid range; and
starting to update the equivalent value of base capacitance when the amount of the touch sensing signal being located in the invalid range is greater than a first default value.

2. The method of claim 1, wherein the invalid range is between the touch threshold and a sum of the equivalent value of base capacitance and a noise margin.

3. The method of claim 1, wherein the invalid range is smaller than a difference between the equivalent value of base capacitance and a noise margin.

4. The method of claim 1, wherein the step of determining the amount of the touch sensing signal being located in the invalid range when the touch sensing signal is located in the invalid range comprises:
accumulating the amount of the touch sensing signal being located in the invalid range in a predetermined duration.

5. The method of claim 1, further comprising:
determining an amount of a plurality of touch sensing signals simultaneously located in a valid range, wherein the valid range is greater than the touch threshold; and
starting to update the equivalent value of base capacitance when the amount of the plurality of touch sensing signals is greater than a second default value.

6. A device for adjusting touch control parameters, for deciding time for updating a touch control parameter of a touch control device, the touch control parameter comprising an equivalent value of base capacitance corresponding to an environmental capacitance and a touch threshold corresponding to a touch event, the device comprising:
a numeric determination unit, for determining an amount of a touch sensing signal being located in an invalid range when the touch sensing signal is located in the invalid range; and
an update trigger unit, for starting to update the equivalent value of base capacitance when the amount of the touch sensing signal being located in the invalid range is greater than a first default value.

7. The device of claim 6, wherein the invalid range is between the touch threshold and a sum of the equivalent value of base capacitance and a noise margin.

8. The device of claim 6, wherein the invalid range is smaller than a difference between the equivalent value of base capacitance and a noise margin.

9. The device of claim 6, wherein the numeric determination unit accumulates the amount of the touch sensing signal being located in the invalid range in a predetermined duration.

10. The device of claim 6, wherein the numeric determination unit is further utilized for determining an amount of a plurality of touch sensing signals simultaneously located in a valid range, wherein the valid range is greater than the touch threshold.

11. The device of claim 10, wherein the numeric determination unit is further utilized for starting to update the equivalent value of base capacitance when the amount of the plurality of touch sensing signals is greater than a second default value.

12. A method for adjusting touch control parameters, for deciding time for updating a touch control parameter of a touch control device, the touch control parameter comprising an equivalent value of base capacitance corresponding to an environmental capacitance and a touch threshold corresponding to a touch event, the method comprising:
determining an amount of a plurality of touch sensing signals simultaneously located in a valid range, wherein the valid range is greater than the touch threshold; and
starting to update the equivalent value of base capacitance when the amount of the plurality of touch sensing signals is greater than a first default value.
